(19) United States
(12) Patent Application Publication
(10) Pub. No.: US 2021/0216068 A1
(43) Pub. Date: Jul. 15, 2021

(54) CONTROL METHOD, CONTROL DEVICE, AND COMPUTER-READABLE STORAGE MEDIUM

(71) Applicant: SZ DJI TECHNOLOGY CO., LTD., Shenzhen (CN)

(72) Inventor: Weiyu MO, Shenzhen (CN)

(21) Appl. No.: 17/214,612

(22) Filed: Mar. 26, 2021

Related U.S. Application Data
(63) Continuation of application No. PCT/CN2018/109066, filed on Sep. 30, 2018.

(51) Int. Cl. G05D 1/00; G05D 1/10; G06F 3/0485; G06F 3/0484; G06F 3/0488; B64C 39/02

(52) U.S. Cl. CPC G05D 1/0016; G05D 1/101; G06F 3/0485; B64C 2201/146; G06F 3/0488; B64C 39/024; G06F 3/04847

(57) ABSTRACT

A control method includes in response to a mode switching operation, generating a mode switching instruction according to the mode switching operation, and switching a control mode of a control device according to the mode switching instruction between a first control mode, under which the control device is used to generate a first instruction to control a mobile platform, and a second control mode, under which the control device is used to generate a second instruction to control a prompt device.

### CROSS-REFERENCE TO RELATED APPLICATION

This application is a continuation of International Application No. PCT/CN2018/109066, filed Sep. 30, 2018, the entire content of which is incorporated herein by reference.

### TECHNICAL FIELD

The present disclosure relates to the field of communication technology and, in particularly, to a control method, a control device, and a computer-readable storage medium.

### BACKGROUND

With the development of video transmission, mobile phones, and displays, most remote-controlled mobile platforms display relevant operation interfaces with mobile phones or external displays, and work with control devices such as remote controls to control mobile platforms. In the process of using the control device to control the mobile platform, one usual way is using both hands of a user to control the device for achieving the control of the basic movement of the mobile platform.

When there is a need to interact with the relevant operation interface displayed on the display, for example, to adjust the relevant parameters of the mobile platform on the display, the hand of the user mobile platform needs to leave the control device to operate the display interface. In this scenario, only one hand or even no hand is used to control the mobile platform. In this process, if an abnormal situation happens to the mobile platform, the user may not control it in time through the control device, which may lead to a major accident. Therefore, in the presence of a mobile platform, a control device, and a prompt device, how to perform safety control has become the focus of current research.

### SUMMARY

In accordance with the disclosure, there is provided a control method including in response to a mode switching operation, generating a mode switching instruction according to the mode switching operation and switching a control mode of a control device according to the mode switching instruction between a first control mode, under which the control device is used to generate a first instruction to control a mobile platform, and a second control mode, under which the control device is used to generate a second instruction to control a prompt device.

### BRIEF DESCRIPTION OF THE DRAWINGS

FIG. 1 is a schematic structural diagram of an example mobile platform control system consistent with the disclosure.

FIG. 2 is a schematic structural diagram of another example mobile platform control system consistent with the disclosure.

FIG. 3 is a schematic flow chart of a control method according to an example embodiment.

FIG. 4 is a schematic structural diagram of an example control device consistent with the disclosure.

FIG. 5A is a schematic diagram showing an example of a control device controlling a prompt device consistent with the disclosure.

FIG. 5B is a schematic diagram showing another example of a control device controlling a prompt device consistent with the disclosure.

FIG. 6 is a schematic diagram showing parameter adjustment of a parameter adjustment element by a dial wheel according to an example embodiment.

FIG. 7 is a schematic structural diagram of another example control device consistent with the disclosure.

### DETAILED DESCRIPTION OF THE EMBODIMENTS

Technical solutions of the present disclosure will be described in detail with reference to the drawings below. It will be appreciated that the described embodiments are some rather than all of the embodiments of the present disclosure. Other embodiments conceived by those having ordinary skills in the art on the basis of the described embodiments without inventive efforts should fall within the scope of the present disclosure.

A control method is provided consistent with the embodiments of the disclosure. The control method is applied to a control device connected with a mobile platform and a prompt device. The platform is connected with the prompt device. The connection between the control device, the mobile platform, and the prompt device may be wired or wireless, such as Bluetooth connection, radio frequency connection, wireless high-fidelity Wi-Fi connection, etc.

In an example embodiment, the mobile platform may be an unmanned aerial vehicle, a car, or a robot, etc. The control device may be a touchscreen device or may be a non-touchscreen device. For example, the control device may be a non-touchscreen remote control with a stick or may be a touchscreen remote control. The prompt device may be a display device including a display screen. For example, the prompt device may be a liquid-crystal display, used to display motion data of the mobile platform during the movement, such as a motion speed, motion environment, etc. The prompt device may also be an indicator device including an indicator. The indicator may be used to indicate whether a current movement condition of the mobile platform meets a preset movement condition. Further, in an example embodiment, the control device and the prompt device may be molded as a whole, for example, the remote control with the stick and display, or a control panel with a button and the indicator, etc. In another example embodiment, the control device and the prompt device are separate from each other. For example, the control device is the remote control, the prompt device is a separate display, which are not limited here.

Further, for example, assuming that the prompt device is the indicator device including a mobile platform movement altitude indicator and a mobile platform movement speed indicator. For the mobile platform movement altitude indicator, when a movement altitude of the mobile platform exceeds an altitude threshold, a red light of the mobile platform movement altitude indicator lights up. When the movement altitude of the mobile platform is less than the altitude threshold, a green light of the mobile platform movement altitude indicator lights up. For the mobile platform movement speed indicator, when a movement speed of the mobile platform exceeds a speed threshold, the red light of the mobile platform movement speed indicator lights up. When the movement speed of the mobile platform is less than the speed threshold, the green light of the mobile platform movement speed indicator lights up. The above-described indicator device and the specific indicator status of the indicator device is only an example embodiment of the indicator device consistent with the embodiments of the present disclosure, which is not limited here.

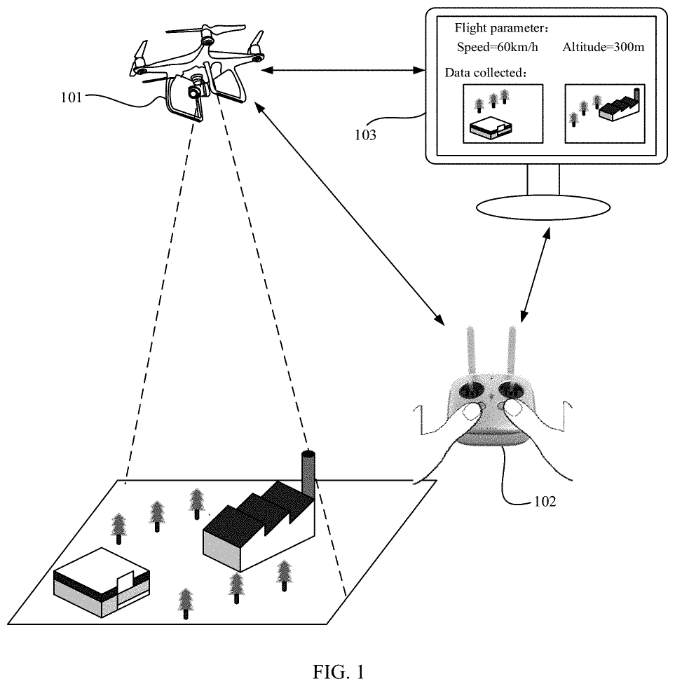

In an example embodiment, the mobile platform performs corresponding operations according to the control instructions of the control device, such as accelerating flight, stopping flight, or steering operation, etc. FIG. 1 is a schematic structural diagram of an example mobile platform control system consistent with the disclosure. As shown in FIG. 1, in an example embodiment, the mobile platform control system includes the mobile platform 101, the control device 102, and the prompt device 103. The mobile platform 101 is the unmanned aerial vehicle, the control device 102 is the remote control, and the prompt device 103 is the display device. The remote control may include a power switch, a power indicator, directional pads, and etc. The power switch is used to control to turn on or turn off the control device 102. When the control device 102 is turned on, the control device 102 may control the mobile platform 101, and when the control device 102 is turned off, the control device 102 may not control the mobile platform 101. The power indicator is used to indicate the power status of the control device 102. The user may determine whether the control device 102 needs to be charged according to the power indicator. The directional pads can be used to control the mobile platform 101 to move in various directions.

In an example embodiment, the prompt device 103 may be used to display a user interface. The user interface may display data to be displayed related to the mobile platform 101. The data to be displayed includes the motion data of the mobile platform 101, and/or data collected by the mobile platform 101. For example, as shown in FIG. 1, the prompt device 103 is the display device including the display screen, a connection between the mobile platform 101 and the prompt device 103 may be a wired or wireless connection. The motion data generated during the movement of the mobile platform 101 or the data collected by the mobile platform 101 is transmitted to the prompt device 103 through the connection, and the prompt device 103 displays received data on the display screen. For example, the mobile platform 101 transmits current flight altitude, flight speed, and currently captured image data to the prompt device 103, and the prompt device 103 displays the received data on the display screen.

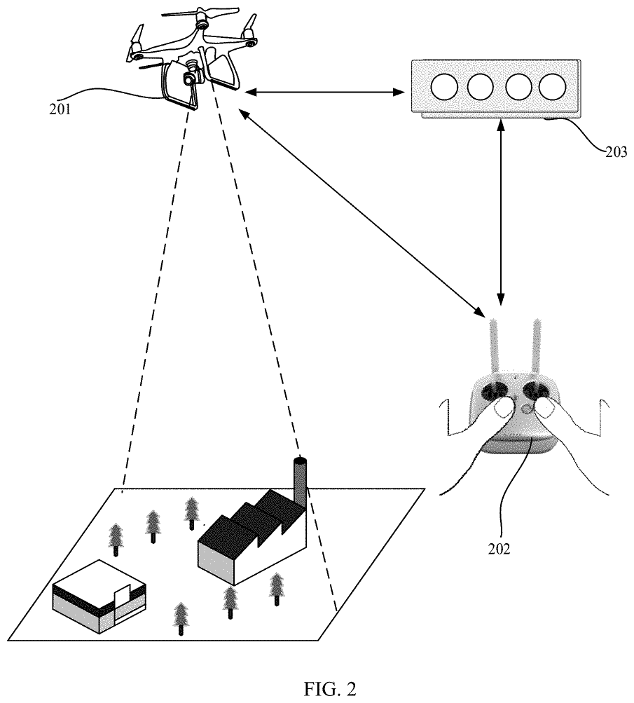

In an example embodiment, the prompt device may also be used to display an indicator interface. FIG. 2 is a schematic structural diagram of another example mobile platform control system consistent with the disclosure. As shown in FIG. 2, the mobile platform 201 is the unmanned aerial vehicle, the control device 202 is the remote control, the indicator device 203 is the indicator device including the indicator. The unmanned aerial vehicle is connected to the remote control and the indicator device. The unmanned aerial vehicle determines flight data generated during flight, for example, whether the flight altitude, the flight speed, and etc., meet preset conditions, and then determines how to control the indicator of the prompt device according to results of judgement.

In an example embodiment, the user may operate the data to be displayed of the mobile platform 101 displayed at the prompt device 103 shown in FIG. 1, and the indicator included in the prompt device 203 shown in FIG. 2, to achieve interaction with the mobile platform. For example, the data to be displayed of the mobile platform 101 displayed at the prompt device 103 includes image sensor parameters when an image sensor of the mobile platform 101 captures an image, and the user may modify the image sensor parameters at the prompt device 103. If the user interacts with the prompt device 103, one hand or even two hands may leave the remote control to operate the prompt device 103. In this scenario, the mobile platform 101 is under no control, which may cause an accident easily. The control device 102 consistent with the embodiments of the present disclosure may not only can control the mobile platform 101, but also can control the prompt device 103. Switching between control of the mobile platform 101 by the control device 102 and control of the prompt device 103 by the control device 102 can be realized by only a switching operation input by the user, thereby ensuring safety of the mobile platform 101.

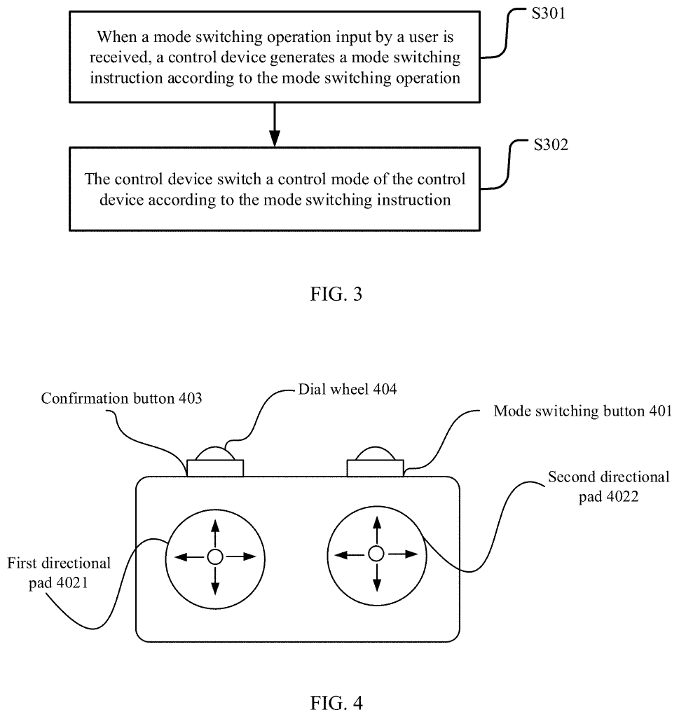

FIG. 3 is a schematic flow chart of a control method according to an example embodiment. In an example embodiment, the control method is applied to the control device connected with the mobile platform and the prompt device, and the prompt device is connected with the mobile platform. The control method may be performed by the control device.

The control method shown in FIG. 3 is applied to the control device, which enables the control device not only to control the mobile platform, but also to control the prompt device, and whether the control device specifically controls the mobile platform or controls the prompt device is determined according to a mode switching instruction of the control device.

At S301, when the mode switching operation input by the user is received, the mode switching instruction is generated by the control device according to the mode switching operation.

In an example embodiment, the mode switching operation input by the user is a preset operation input by the user at a mode switching button. That is, the control device may include the mode switching button, when the preset operation input by the user is received at the mode switching button, the mode switching operation input by the user at the control device is determined, and then the mode switching instruction is generated according to the mode switching operation input by the user.

In an example embodiment, the preset operation may be preset by the control device. The control device presets the preset operation and specifies that the mode switching instruction is generated only when an operation input by the user detected on the mode switching button is the preset operation, thereby avoiding control mode switching of the control device caused by a mistaken operation by the user at the mode switching button, and saving power for the control device. In an example embodiment, the preset operation includes one or more of a preset press operation, a preset scroll operation, and a preset rotate operation. The preset press operation may include pressing the mode switching button, releasing the mode switching button, continuously pressing mode switching button N times in a preset time, or holding the mode switching button M seconds, etc., where both N and M are positive integers greater than 1. The preset scroll operation may be scrolling the mode switching button to a preset direction for a preset number of times. The preset rotate operation may be rotating the mode switching button to the preset direction for the preset number of times. Only some optional preset operations are listed in the embodiments of the present disclosure, which are not limited here.

After the mode switching instruction is generated by the control device according to the mode switching operation, at S302, the control mode of the control device is switched by the control device according to the mode switching instruction. In an example embodiment, the control device includes a first control mode and a second control mode. When the control device is under the first control mode, a first instruction generated by the control device is used to control the mobile platform, and when the control device is under the second control mode, a second instruction generated by the control device is used to control the prompt device.

In an example embodiment, the mode switching instruction may include a switching instruction to control the control device to switch the control mode of the control device. The control mode switching of the control device may be implemented by determining a current control mode of control device, and switching the control mode of the control device according to the current control mode and the mode switching instruction. That is, if the switching instruction included in the mode switching instruction is used to control the control device to switch the control mode of the control device, before the control device switches the control mode according to the mode switching instruction, the current control mode of the control device is determined at first. If the current control mode of the control device is the first control mode, then the control device switches the control mode of the control device from the first control mode to the second control mode according to the mode switching instruction. Similarly, if the current control mode of the control device is the second control mode, the control device switches the control mode of the control device from the second control mode to the first control mode according to the mode switching instruction.

In another example embodiment, the mode switching instruction may include the switching instruction used to control the control device to switch control mode and the switching operation. The switching operation is used to indicate which control mode the control device switches to, for example, the switching operation indicates that the control device switches to the first control mode or the second control mode. In an example embodiment, if the mode switching operation input by the user and the control mode of the control device are determined in a corresponding relationship with each other in advance, the control device may generate the mode switching instruction according to the mode switching operation input by the user by obtaining the control mode corresponding to the mode switching operation input by the user, and generating the mode switching instruction according to the control mode.

For example, assuming that the corresponding relationship between the mode switching operation and the control mode determined in advance by the control device is that pressing the mode switching button twice in 5 seconds corresponds to the first control mode, and long pressing the mode switching button for 3 seconds corresponds to the second control mode. If the mode switching operation input by the user detected by the control device is the long pressing the mode switching button for 3 seconds, then the control mode corresponding to the mode switching operation is the second control mode is determined, and the control device further generates the mode switching instruction with the second control mode. Therefore, the mode switching instruction includes both the switching instruction used to control the control device to switch the control mode and a specific switching operation.

In an example embodiment, if the mode switching instruction includes both the switching instruction to control the control device to switch the control mode and the specific switching operation, switching the control mode of the control device according to the mode switching instruction of process S302 may be implemented by obtaining the control mode included in the mode switching instruction, and then switching the control mode of the control device to the control mode included in the mode switching instruction. In an example embodiment, before switching the control mode of the control device to the control mode included in the mode switching instruction, the control device may also determine whether the current control mode of the control device is the same as the control mode included in the mode switching instruction. If the current control mode of the control device is the same as the control mode included in the mode switching instruction, then the control mode of the control device is not switched. If the current control mode of the control device is different from the control mode included in the mode switching instruction, then the control mode of the control device is switched to the control mode included in the mode switching instruction, thereby saving the power of the control device.

In an example embodiment, the control method shown in FIG. 3 may be applied to the working scene of the mobile platform shown in FIG. 1. The prompt device shown in FIG. 1 may be used to display the user interface. When the control device is under the second control mode, the second instruction generated by the control device is used to control the user interface displayed on the prompt device. FIG. 4 is a schematic structural diagram of an example control device consistent with the disclosure.

As shown in FIG. 4, in an example embodiment, the control device includes a mode switching button 401. When the preset operation input by the user is detected on the mode switching button 401, the control device switches the control mode of the control device. In an example embodiment, the control device also includes at least one directional pad, for example, the control device shown in FIG. 4 includes a first directional pad 4021 and a second directional pad 4022. When a user operation is received on a target directional pad of the at least one directional pad, the control device under the first control mode generates a movement control instruction to control a movement direction of the mobile platform according to the user operation on the target directional pad. When the user operation is received on the target directional pad of the at least one directional pad, the control device under the second control mode generates the movement control instruction to control a selection identifier displayed at the prompt device according to the user operation on the target directional pad.

In some embodiments, the target directional pad may include any directional pad of the at least one directional pad or include all the directional pads of the at least one directional pad. When the control device is under the first control mode, the control device is used to control the mobile platform. Therefore, the control device generates the movement control instruction to control the movement of the mobile platform according to the user operation on the target directional pad. That is, the control instruction generated by the control device under the first control mode is applied to the mobile platform. The control device may generate the movement control instruction according to the user operation on the target directional pad by obtaining the movement direction indicated by the user operation, and generating the movement control instruction according to the movement direction. If the movement control instruction includes the movement direction, then the control device controls the mobile platform to move according to the movement direction included in the control instruction. For example, assuming that the control device is the remote control, the target directional pad on the remote control is the stick. If a left-turning user operation is detected on the stick, the movement direction included in the movement control instruction is left, and the control device controls the mobile platform to move to the left.

When the control device is under the second control mode, the control device is used to control the prompt device. Therefore, the control device generates the movement instruction to control the selection identifier displayed at the prompt device according to the user operation on the target directional pad. That is, the movement control instruction generated by the control device under the second control mode is executed to the prompt device. The control device may generate the movement control instruction for the selection identifier displayed in the control prompt device according to the user operation on the target directional pad by obtaining the movement direction indicated by the user operation, and generating the movement control instruction according to the movement direction. In an example embodiment, the selection identifier displayed at the prompt device includes a cursor. The control device controls the cursor to move according to the movement direction included in the movement instruction.

In another example embodiment, when the user operation is received on the target directional pad of the at least one directional pad, the control device under the second control mode generates a selection instruction to select an interface element displayed at the prompt device according to the user operation on the target directional pad. The interface element is generated according to the data to be displayed. For example, the interface element may be the motion data of the mobile platform, and/or the data collected by the mobile platform. In some embodiments, the selection instruction is used to control the movement of a display box, a corresponding movement direction is detected by the user operation on the directional pad of the control device, and the control device then generates the selection instruction including the movement direction. For example, if the movement direction is up, then the display box currently displayed at the prompt device is controlled to move up, to cause a certain interface element to be displayed in the display box indicating that the certain interface element is selected to the user.

In summary, when the control device is under the second control mode, the target directional pad may be regarded as an external mouse of the prompt device, which may control the selection identifier, e.g., the cursor, of the prompt device, and the selection instruction, e.g., the display box, to control the user interface of the prompt device.

In an example embodiment, the control device shown in FIG. 4 also includes a confirmation button 403. After generating the movement control instruction to control the selection identifier displayed at the prompt device, when a confirmation operation on the confirmation button is detected, the control device generates a confirmation instruction according to the confirmation operation, and controls to display a target interface element on the user interface of the prompt device according to the confirmation instruction. In some embodiments, the target interface element is the interface element corresponding to the selection identifier after the selection identifier is controlled to be moved to a target location according to the movement control instruction. That is, if the user wants to select the target interface element of the prompt device by the control device, the control operation with the movement direction is input on the target directional pad at first, to enable the control device to control selection identifier of the prompt device to be moved to the target location. Then the confirmation operation is input by the user on the confirmation button, thereby achieving selection of the target interface element of the prompt device.

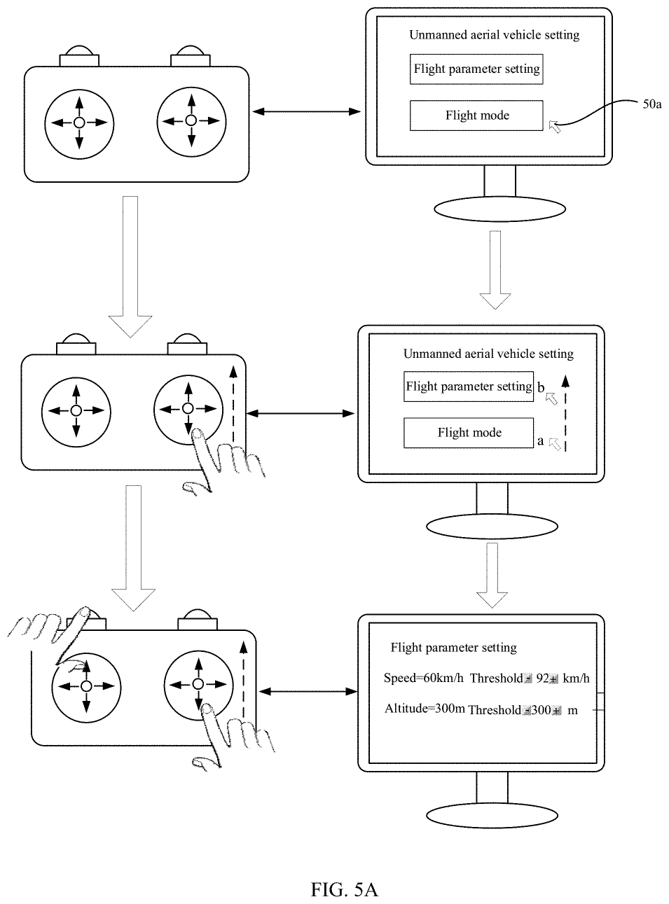

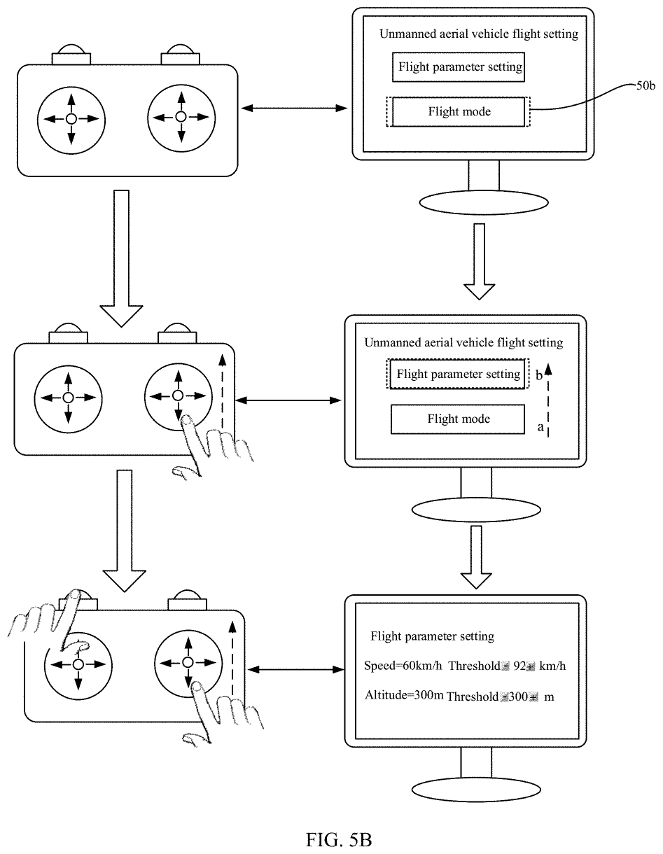

FIG. 5A is a schematic diagram showing an example of a control device controlling a prompt device consistent with the disclosure. As shown in FIG. 5A, in an example embodiment, the control device is the remote control, the remote control includes two directional pads, the confirmation button, and the mode switching button. The control mode of the control device is switched to the second control mode according to the preset operation by the user on the mode switch button. The interface element on the user interface included in the prompt device may be a function menu of the mobile platform, and the selection identifier is a cursor 50a. Assuming that the control cursor 50a is moved from position a to position b according to the user operation on the directional pad. In this scenario, the confirmation operation by the user on the confirmation button of control device is detected, and the control device may determine that the user has selected the flight parameter setting at the position b. Then the control device controls to display the interface elements in a flight parameter setting menu at the prompt device. In an example embodiment, the directional pads, the confirmation button, and the mode switching button may be mechanical buttons, or may be virtual buttons on a touchscreen.

In an example embodiment, the control device shown in FIG. 4 also includes the confirmation button 403. After generating the selection instruction to select the interface element displayed at the prompt device, when the confirmation operation on the confirmation button is detected, the control device generates the confirmation instruction according to the confirmation operation, and controls to display the target interface element on the user interface of the prompt device according to the confirmation instruction. In some embodiments, the target interface element is the interface element selected by the selection instruction on the user interface. That is, when the confirmation operation on the confirmation button is detected, the control device controls to display the interface element selected by the selection instruction at the prompt device. FIG. 5B is a schematic diagram showing another example of a control device controlling a prompt device consistent with the disclosure. As shown in FIG. 5B, in an example embodiment, the selection identifier is a display box 50b, the control device determines that the display box is moved from the interface element originally selected (i.e., flight mode) up to the interface element determinedly selected (i.e., flight parameter setting). For the specific implementation processes, reference may be made to the description of the embodiments shown in FIG. 5A, which are omitted here.

In an example embodiment, the control device shown in FIG. 4 also includes a dial wheel 404, which may be a dial wheel above the confirmation button 403 or a dial wheel above the mode switching button 401, or may be set separately at another suitable position of the control device. In an example embodiment, the dial wheel 404 is set above the confirmation button 403 to facilitate user to operate. Further, after generating the selection instruction to select the interface element displayed at the prompt device, a first scroll operation on the dial wheel is received by the control device. If the interface element selected by the selection instruction on the user interface is a parameter adjustment element, the control device generates an adjustment instruction to adjust the parameter adjustment element according to the first scroll operation. In an example embodiment, a parameter adjustment interface on the user interface may also be corresponding to the selection identifier. That is, if the interface element selected by the selection instruction or the interface element corresponding to the selection identifier is the parameter adjustment element, the dial wheel of the control device may be used to adjust a parameter of the parameter adjustment element.

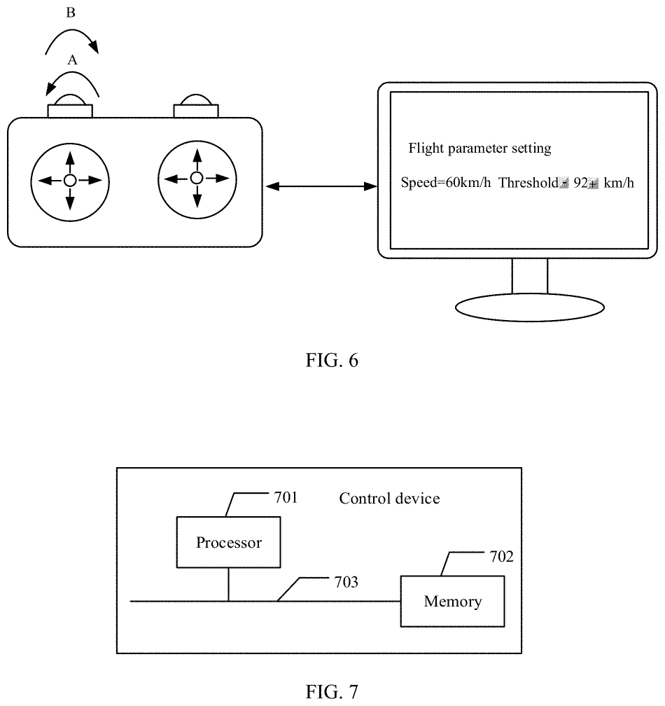

FIG. 6 is a schematic diagram showing an example of adjusting a parameter interface element using a dial wheel according to an example embodiment. On the basis of FIG. 5B, assume that the interface element displayed at the prompt device is the parameter adjustment element, for example, the speed threshold of movement of the mobile platform or the altitude threshold of movement of the mobile platform. If a scroll operation on the dial wheel is scrolling the dial wheel along the scroll direction A as shown in FIG. 6, a preset value of a corresponding motion speed parameter may be lowered. If the scroll operation on the dial wheel is scrolling the dial wheel along the scroll direction B as shown in FIG. 6, the preset value of the corresponding motion speed parameter may be higher. Only some possible parameter adjustment methods are listed in the embodiments of the present disclosure, which are not limited here. The specific parameter adjustment methods may be determined according to different working scenarios of the mobile platform or may be specified according to the performance of the mobile platform.

In some embodiments, the control device may also preset the first directional pad 4021 of the at least one directional pad as the target directional pad. When the user operation on the first directional pad 4021 is received, the control device generates the movement control instruction to control to move the selection identifier of the prompt device or generates the selection instruction to select the interface element of the prompt device. The second directional pad 4022 is used as a parameter adjustment pad. When the user operation on the second directional pad 4022 is received, the control device generates parameter adjustment instruction to adjust the parameter adjustment element of the prompt device. Alternatively, when the user operation on the dial wheel 404 is received, the control device generates the movement control instruction or the selection instruction. In short, when the user operation on any button/pad of the control device shown in FIG. 4 is received, what function the control device under the second control mode specifically controls the prompt device to achieve is not limited to the embodiments of the present disclosure. In some embodiments, the control device shown in FIG. 4 may also include a power button (not shown), the power indicator (not shown), and etc.

In summary, if the control method consistent with the embodiments shown in FIG. 3 is applied to the control device shown in FIG. 4, and the control device is under the second control mode, when the user operation on each of the mode switching button 401, the directional pads, the confirmation button 403, and the dial wheel 404 is received, the control device generates a different instruction to control the user interface of the prompt device, thereby realizing interaction with the prompt device through the control device for the user. In general terms, the control device shown in FIG. 3 applying the control method may control both the mobile platform and the prompt device, which enables the user to interact with the prompt device without taking the hand off the remote control, thereby improving the efficiency of the interaction between the user and the prompt device and ensuring the safety of the mobile platform by switching back to control the mobile platform more quickly for emergency.

In an example embodiment, the control device shown in FIG. 3 may preset the directional pads to be always used to control the movement direction of the mobile platform no matter whether the control device is under the first control mode or under the second control mode, and may preset the dial wheel and the confirmation button are used to control the prompt device when the control device is under the second control mode. Therefore, the mobile platform is not under the condition of no control when the control device is under the second control mode. When the user interacts with the prompt device, if the mobile platform is found being deviated from the movement direction, the user may quickly operate the directional pads to control the mobile platform. In this scenario, the control device simultaneously achieves the interaction with the prompt device and achieves controlling of the mobile platform, thereby enhancing the user experience of the mobile platform, and ensuring the safety of the mobile platform.

In an example embodiment, when a second scroll operation on the dial wheel is detected, the control device under the second control mode generates the movement control instruction to control the selection identifier displayed at the prompt device according to the second scroll operation. In another example embodiment, the control device also generates the selection instruction to select the interface elements displayed at the prompt device according to the second scroll operation. That is, if the dial wheel is used as a control button to control the prompt device, the control device under the second control mode may control the selection identifier of the prompt device to move or generate the selection instruction when the user operation is received.

In an example embodiment, after generating the confirmation instruction to control the selection identifier displayed at the prompt device according to the second scroll operation, when the confirmation operation is detected on the confirmation button, the control device generates the confirmation instruction according to the confirmation operation and controls to display the target interface element on the user interface of the prompt device according to the confirmation operation. In some embodiments, the target interface element is the interface element corresponding to the selection identifier after the selection identifier is controlled to be moved to the target location according to the movement control instruction. That is, the user may control the selection identifier displayed at the prompt device to move to the target location by the dial wheel, and then click the confirmation button to select the interface element to corresponding the selection identifier at this time. The interface element selected by the user is then displayed at the prompt device according to the confirmation operation input by the user.

In some embodiments, after generating the selection instruction to select the interface element displayed at the prompt device, when the confirmation operation is detected on the confirmation button, the control device generates the confirmation instruction according to the confirmation operation and control to display the target interface element on the user interface of the prompt device according to the confirmation instruction. The target interface element is the interface element selected by the selection instruction on the user interface. The user may generate the selection instruction in the prompt device via the dial wheel, and then control to display the interface element corresponding to the selection instruction at the prompt device via the confirmation button.

In an example embodiment, after generating the selection instruction to select the interface element displayed at the prompt device, when a third scroll operation is detected on the dial wheel, if the interface element selected by the selection instruction on the user interface is the parameter adjustment element, the control device generates the adjustment instruction to adjust the parameter of the parameter adjustment element according to the third scroll operation. In some embodiments, for the description of generating the adjustment instruction to adjust the parameter of the parameter adjustment element by the control device, reference may be made to the description of the control device shown in FIG. 4, which is omitted here.

In the control method consistent with the embodiments shown in FIG. 3, the control device generates the mode switching instruction according to the received user operation, switches the control mode of the control device according to the mode switching instruction, and controls both the mobile platform and the prompt device. Both the mobile platform and the prompt device may be controlled by the single control device, thereby improving the efficiency of the interaction between the user and the prompt device, and ensuring the safety of the mobile platform.

FIG. 7 is a schematic structural diagram of an example control device consistent with the disclosure. As shown in FIG. 7, the control device is connected to the mobile platform, the mobile platform is connected with the prompt device, and the control device is connected with the prompt device. For descriptions of the specific connections, reference may be made to the above-described embodiments, which are omitted here. The control device includes a processor 701 and a memory 702, the memory 702 and the processor 701 are connected by a bus 703, and the memory 702 stores a computer program.

The memory 702 may include a volatile memory such as a random-access memory (RAM). The memory 702 may include a non-volatile memory, such as flash memory, solid-state drive (SSD), etc. The memory 702 may include a combination of the above types of memory.

The processor 701 may be a central processing unit (CPU). The processor 701 may include a hardware chip. The hardware chip may be an application-specific integrated circuit (ASIC), or a programmable logic device (PLD), etc. The PLD may be a field-programmable gate array (FPGA), or a generic array logic (GAL), etc. The processor 701 may be the combination of above structures.

In the embodiments of the disclosure, the memory 702 stores a computer program including program instructions, the processor 701 is configured to execute the computer program stored in the memory 702 to implement a process of corresponding method consistent with the disclosure, such as the example embodiment shown in FIG. 3.

In an example embodiment, the processor 701 is configured to execute the computer program stored in the memory 702 to implement the corresponding method consistent with the embodiments shown in FIG. 3. The processor 701 is configured to execute the computer program to generate a mode switching instruction according to a mode switching operation when the mode switching operation is received from the user, and to switch a control mode of a control device according to the mode switching instruction. In an example embodiment, the control mode includes a first control mode and a second control mode. The control device under the first control mode generates a first instruction used to control a mobile platform, and the control device under a second control mode generates a second instruction used to control a prompt device.

In an example embodiment, the prompt device is used to display a user interface, and the second instruction is used to control the user interface displayed at the prompt device.

In an example embodiment, the control device includes at least one directional pad. The processor 701 is configured to execute the computer program to generate a control instruction to control a movement direction of the mobile platform according to a user operation on a target directional pad under the first control mode when the user operation is received on the target directional pad of the at least one directional pad, and to generate a movement control instruction to control a selection identifier displayed at the prompt device according to a user operation on a target directional pad under the second control mode when the user operation is received on the target directional pad of the at least one directional pad.

In an example embodiment, the control device includes at least one directional pad. The processor 701 is configured to execute the computer program to generate a selection instruction to select an interface element displayed at the prompt device according to a user operation on the target directional pad under the second control mode when the user operation is received on the target directional pad of the at least one directional pad. The interface element is generated according to data to be displayed.

In an example embodiment, the control device also includes a confirmation button. After generating the movement control instruction to control the selection identifier displayed at the prompt device, the processor 701 is configured to execute the computer program to generate a confirmation instruction according to a confirmation operation when the confirmation operation on the confirmation button is detected, and to control to display a target interface element on the user interface of the prompt device. The target interface element is an interface element corresponding to the selection identifier after the selection identifier is moved to a target location according to the movement control instruction.

In an example embodiment, the control device also includes a confirmation button. After generating the selection instruction to select the interface element displayed at the prompt device, the processor 701 is configured to execute the computer program to generate a confirmation instruction according to a confirmation operation when the confirmation operation on the confirmation button is detected, and to control to display a target interface element on the user interface of the prompt device. The target interface element is an interface element selected on the user interface according to the selection instruction.

In an example embodiment, the control device also includes a dial wheel, after generating the selection instruction to select the interface element displayed at the prompt device, the processor 701 is configured to execute the computer program to receive a first scroll operation on the dial wheel, and to generate an adjustment instruction for parameter adjustment of the parameter adjustment element according to the first scroll operation when the interface element selected by the selection instruction on the user interface is the parameter adjustment element.

In an example embodiment, the control device includes a dial wheel, the processor 701 is configured to execute the computer program to generate a movement control instruction to control the selection identifier displayed at the prompt device according to a second scroll operation under the second control mode when the second scroll operation of the dial wheel is detected.

In an example embodiment, the control device includes a dial wheel, the processor 701 is configured to execute the computer program to generate a selection instruction to select the interface element displayed at the prompt device according to a second scroll operation under the second control mode when the second scroll operation of the dial wheel is detected.

In an example embodiment, the control device also includes a confirmation button. After generating the movement control instruction to control the selection identifier displayed at the prompt device according to the second scroll operation, the processor 701 is configured to execute the computer program to generate a confirmation instruction according to a confirmation operation when the confirmation operation on the confirmation button is detected, and to control to display a target interface element on the user interface of the prompt device according to the confirmation instruction. The target interface element is an interface element corresponding to the selection identifier after the selection identifier is controlled to be moved to a target location according to the movement control instruction.

In an example embodiment, the control device also includes a confirmation button. After generating the selection instruction to select the interface element displayed at the prompt device, the processor 701 is configured to execute the computer program to generate a confirmation instruction according to a confirmation operation when the confirmation operation on the confirmation button is detected, and to control to display a target interface element on the user interface of the prompt device. The target interface element is an interface element selected on the user interface according to the selection instruction.

In an example embodiment, after generating the selection instruction to select the interface element displayed at the prompt device, the processor 701 is configured to execute the computer program to receive a third scroll operation on a dial wheel, and when the interface element selected by the selection instruction on the user interface is the parameter adjustment element, to generate an adjustment instruction for the parameter adjustment of the parameter adjustment element according to the third scroll operation.

In an example embodiment, the mode switching operation input by the user is a preset operation input by the user on the mode switching button, including one or more of a preset press operation, a preset scroll operation, and a preset rotate operation.

In an example embodiment, the control device includes a touchscreen device.

In an example embodiment, the prompt device includes a display device including a display screen or an indicator device including an indicator.

In an example embodiment, the user interface of the prompt device displays data to be displayed related to a mobile platform, and the data to be displayed includes motion data of the mobile platform, and/or data collected by the mobile platform.

Ordinary skill in the art may understand some or all of the above-described embodiments may be implemented in the form of computer program to instruct relevant hardware to complete. The program may be stored in a computer-readable storage medium, and execution of the program may include implementation of the process of the method consistent with the above-described embodiments. The storage medium may be any medium that may store program codes, for example, a magnetic disk, an optical disk, a read-only storage memory (e.g., read-only memory, i.e., ROM), or a random storage memory (e.g., random-access memory, i.e., RAM).

Although the above has shown and described the embodiments of the present disclosure, it is intended that the above embodiments be considered as examples only and not to limit the scope of the present disclosure. One of ordinary skill in the art may make changes, modifications, replacements, and transformation to the above embodiments within the scope of the present disclosure. The scope of the invention is defined by the claims and their equivalents.

What is claimed is:

1. A control method comprising:
in response to a mode switching operation, generating a mode switching instruction according to the mode switching operation; and
switching a control mode of a control device according to the mode switching instruction between:
a first control mode, under which the control device is configured to generate a first instruction to control a mobile platform; and
a second control mode, under which the control device is configured to generate a second instruction to control a prompt device.

2. The method of claim 1, wherein:
the prompt device is configured to display a user interface; and
the second instruction is configured to control the user interface displayed at the prompt device.

3. The method of claim 2, further comprising:
under the first control mode, in response to a user operation on a target directional pad of the control device, generating a control instruction to control a movement direction of the mobile platform according to the user operation; or
under the second control mode, in response to the user operation on the target directional pad, generating a movement control instruction to control a selection identifier displayed at the prompt device according to the user operation.

4. The method of claim 3, further comprising, after generating the movement control instruction:
in response to a confirmation operation on a confirmation button of the control device, generating a confirmation instruction according to the confirmation operation; and
performing a display control on a target interface element on the user interface of the prompt device according to the confirmation instruction;
wherein the target interface element is an interface element that the selection identifier corresponds to after moving to a target location according to the movement control instruction.

5. The method of claim 2, further comprising:
under the second control mode, in response to a user operation on a target directional pad of the control device, generating a selection instruction to select an interface element displayed at the prompt device according to the user operation.

6. The method of claim 5, further comprising, after generating the selection instruction:
in response to a confirmation operation on a confirmation button of the control device, generating a confirmation instruction according to the confirmation operation; and
performing a display control on a target interface element on the user interface of the prompt device according to the confirmation instruction;
wherein the target interface element is the interface element selected according to the selection instruction.

7. The method of claim 5, further comprising, after generating the selection instruction:
receiving a scroll operation on a dial wheel of the control device; and
in response to the interface element selected by the selection instruction being a parameter adjustment element, generating an adjustment instruction for parameter adjustment of the parameter adjustment element according to the scroll operation.

8. The method of claim 2, further comprising:
under the second control mode, in response to a scroll operation on a dial wheel of the control device, generating a movement control instruction to control a selection identifier displayed at the prompt device according to the scroll operation.

9. The method of claim 8, further comprising, after generating the movement control instruction:
in response to a confirmation operation on a confirmation button of the control device, generating a confirmation instruction according to the confirmation operation; and
performing a display control on a target interface element on the user interface of the prompt device according to the confirmation instruction;
wherein the target interface element is an interface element that the selection identifier corresponds to after moving to a target location according to the movement control instruction.

10. The method of claim 2, further comprising:
under the second control mode, in response to a scroll operation on a dial wheel of the control device, generating a selection instruction to select an interface element displayed at the prompt device according to the scroll operation.

11. The method of claim 10, further comprising, after generating the selection instruction:
in response to a confirmation operation on a confirmation button of the control device, generating a confirmation instruction according to the confirmation operation; and
performing a display control on a target interface element on the user interface of the prompt device according to the confirmation instruction;
wherein the target interface element is the interface element selected by the selection instruction on the user interface.

12. The method of claim 10, further comprising, after generating the selection instruction:
receiving another scroll operation on the dial wheel;
in response to the interface element selected by the selection instruction being a parameter adjustment element, generating an adjustment instruction for a parameter adjustment of the parameter adjustment element according to the another scroll operation.

13. The method of claim 1, wherein the mode switching operation includes one or more of a press operation, a scroll operation, and a rotate operation on a mode switching button.

14. The method of claim 1, wherein the control device includes a touchscreen device.

15. The method of claim 1, wherein the prompt device includes:
a display device including a display screen; or
an indicator device including an indicator.

16. The method of claim 1, wherein:
the prompt device includes a user interface configured to display data to be displayed related to the mobile platform; and
the data to be displayed includes at least one of motion data of the mobile platform or data collected by the mobile platform.
